(19) United States
(12) Patent Application Publication
(10) Pub. No.: US 2004/0099603 A1
(43) Pub. Date: May 27, 2004

(54) Method for separating a phase transfer catalyst by means of a membrane

(76) Inventor: Andrew Guy Livingston, Flats (GB)

Correspondence Address: Scott A McCollister, Fay Sharpe Fagan Minnich & McKee, 7th Floor, 1100 Superior Avenue, Cleveland, OH, 44114-2518, US

(21) Appl. No.: 10/432,586

(22) PCT Filed: Nov. 19, 2001
(86) PCT No.: PCT/GB01/05093

(30) Foreign Application Priority Data
Nov. 24, 2000 (GB) 0028705.2

(51) Int. Cl. B01D 61/00

(52) U.S. Cl. 210/649; 210/650; 210/651

(57) ABSTRACT

There is provided a process for separating at least one phase transfer agent (PTA) from an organic liquid mixture containing at least one organic solvent and at least one PTA, in which the organic liquid mixture is brought into contact with one surface of a selectively permeable membrane and pressure is applied to the organic liquid mixture which causes a fraction of the organic liquid to permeate through the membrane and exit at the other surface, such that the concentration of the at least one PTA in the fraction of organic liquid which does not permeate the membrane increases while the concentration of the at least one PTA in the fraction of organic liquid which permeates through the membrane is less than the concentration of the at least one PTA in the original mixture.

The present invention relates to phase transfer catalysis. In another aspect, it relates to a process for separation of phase transfer catalysts from organic liquids. In another aspect it relates to re-use of phase transfer catalysts following separation. In another aspect it relates to the use of phase transfer catalysts in organic synthesis reactions. In particular the process comprises separating and recovering the phase transfer catalyst from an organic liquid phase. In a further variation of the process the separated phase transfer catalyst may be re-used in subsequent reactions.

Since the mid-1960s, phase-transfer catalysis has been developed on a laboratory and industrial scale. Phase transfer catalytic (henceforth PTC) reactions, typical catalysts (henceforth phase transfer agents, PTA) and examples of the reactions catalysed are described in numerous texts on the subject, such as “Phase Transfer Catalysis: Fundamentals, Applications and Industrial Perspectives” Starks C. M., Liotta C. L., Halpern M. Chapman and Hall, New York (1994) “Phase Transfer Catalysis” Dehmlow E. V. and Dehmlow S. S, 3^{rd} Edn, Verlag Chemie, Weinheim, (1993) and “Handbook of Phase Transfer Catalysis” Sasson Y. and Neumann R, Blackie, London (1997). In these books and in recent articles such as “Phase Transfer Catalysis: Chemistry and Engineering” S. D. Naik and L. K. Doriswarmy, American Institution of Chemical Engineers Journal March 1998 Vol 44 No.3 pp 612-646, the need for suitable technologies to remove PTAs from waste streams exiting the PTC reactions has been highlighted. For example Naik and Doriswarmy state “Separation of the soluble PT catalyst from the reaction mixture is usually a detailed process. However, it is becoming more and more crucial to develop technology to recover and re-use the PT catalysts due to increasing costs of the catalysts, as well as environmental concerns regarding the toxicity of quats and crown ethers in effluent streams from these processes” (p640).

Starks, Liotta and Halpern (1994) describe techniques which have been proposed to separate and recycle PTAs. These include extraction into water, distillation of product overhead, and adsorption onto silica. These techniques are reviewed by Naik and Doriswarmy (1998) page 640.

Yet further techniques have been proposed in the patent literature, based on various forms of water washing followed by solvent extraction. In U.S. Pat. No. 4,520,204, a method for the production of aromatic etherimides is described using tetraalkylammonium halide phase-transfer catalysts, where o-dichlorobenzene is used to extract the phase-transfer catalyst from the water used to wash the product; later, under one option of the method, this catalyst is recycled. One to two volumes of o-dichlorobenzene were used per volume of aqueous phase, and the o-dichlorobenzene was recovered by vacuum evaporation. Percent recovery of catalyst from wash solution was as low as 5% but could be increased to as high as 80% by adding sodium nitrite and heating to 67° C.

U.S. Pat. No. 5,030,757 describes a system in which a quaternary ammonium salt PTA is recovered from mixtures where the salt is in contact with an aqueous alkaline phase by adding water to completely dissolve the salt and then adding base to cause the dissolved catalyst to separate as a hydroxide which forms an oily upper phase. It is claimed that this oily upper phase can be successfully used to catalyse a second reaction producing methylcylcopentadiene.

U.S. Pat. No. 5,675,029 describes a cyclic process for activation, use and recovery of phase transfer catalysts through extraction into a washwater followed by recovery from the washwater by addition of an alcohol and a salting-out agent.

Membrane processes are well known in the art of separation science, and can be applied to a range of separations of species of varying molecular weights in liquid and gas phases (see for example “Membrane Technology” in Kirk Othmer Encyclopedia of Chemical Technology, 4^{th} Edition 1993, Vol 16, pages 135-193). Membranes for use in phase contacting processes driven by concentration differences between two immiscible phases have been available for some time in forms that are resistant to organic solvents and membrane solvent extraction using microporous membranes to provide phase contacting between aqueous and organic streams is well known. For example Kiani, Bhave and Sirkar Journal of Membrane Science 20 (1984) pp 125-145 report the use of microporous membranes for immobilising solvent interfaces during solvent extraction. Tompkins, Micheals and Peretti Journal of Membrane Science 75 (1992) pp 277-292 report using microporous polypropylene fibres to stabilise phase interfaces during extraction of nitrophenol from an aqueous solution into octanol. U.S. Pat. No. 5,512,180 describes a process wherein polypropylene glycol MW 4000 was used to extract nitrophenol in a microporous membrane contactor. U.S. Pat. No. 4,795,704 describes a multiphase membrane reactor in which an asymmetric membrane is used to contain a catalytic species in a membrane separating two immiscible liquid streams. U.S. Pat. No. 4,754,089 describes a process in which a membrane permeable to PTAs is used to stabilise the interface between organic and aqueous phases in a liquid-liquid PTC reaction. All of these above processes employ two immiscible phases whose interface is stabilised by the membrane. The membranes reported for use in these processes are microporous membranes generally with an average pore size of greater than 10 nm and molecular weight cutoffs above 5,000 Daltons.

Nanofiltration is a membrane process utilising membranes whose pores are in the range 0.5-5 nm, and which have MW cutoffs of 200-5000 Daltons. Nanofiltration has been widely applied to filtration of aqueous fluids, but due to a lack of suitable solvent stable membranes has not been widely applied to separation of solutes in organic solvents. U.S. Pat. No. 5,205,934 and U.S. Pat. No. 5,265,734 describe processes for producing composite nanofiltration membranes which comprise a layer of silicone immobilised onto a support, preferably a polyacrylonitrile support. These composite membranes are claimed to be solvent stable and are claimed to have utility for separation of high molecular weight solutes, including organometallic catalyst complexes, from organic solvents. The performance of these composite membranes in separating solutes from methanol solutions has been described in the open literature (“Nanofiltration studies of larger organic microsolutes in methanol solutions”, Whu J. A., Baltzis B. C., Sirkar K. K. Journal of Membrane Science 170 (2000) pages 159-172). U.S. Pat. No. 5,264,166 describes processes for the production of asymmetric polyimide membranes which are claimed to be stable in solvents such as toluene, benzene, xylene, methyl ethyl ketone (MEK) and methyl iso butyl ketone (MIBK). These asymmetric membranes are claimed to have utility for the separation of low molecular weight organic materials with a molecular weight in the range 300-400 from solvents with molecular weight of around 100.

The use of membranes to separate catalysts from organic solvents is known in the art and has been described in the open literature. “Reverse Osmosis in Homogeneous Catalysis” Gosser L. W., Knoth W. H., Parshall G. W. Journal of Molecular Catalysis 2 (1977) pages 253-263 describes experiments using selectively permeable polyimide membranes to separate soluble transition metal catalysts from reaction mixtures by reverse osmosis. “Modeling of nanofiltration—assisted organic synthesis”, J. A. Whu, B. C. Baltzis, K. K. Sirkar, Journal of Membrane Science, 163 (1999) 319-331 describes modelling used to investigate the potential application of solvent stable nanofiltration membranes to catalyst separation and recycle.

The patent literature also describes the use of membranes to separate catalysts from organic solvents. U.S. Pat. No. 5,174,899 discloses the separation of organometallic compounds and/or metal carbonyls from their solutions in organic media with the aid of semi-permeable membranes made of aromatic polyamides.

U.S. Pat. Nos. 5,215,667; 5,288,818 5,298,669 and 5,395,979 describe the use of a hydrophobic membrane to separate water-soluble noble metal ionic phosphine ligand complex catalysts from aldehyde containing hydroformylation reaction mediums comprising aqueous solutions, emulsions or suspensions of said catalysts. U.S. Pat. No. 5,681,473 describes the application of solvent-resistant composite membranes to separation of organic-solubilised rhodium-organophosphite complex catalyst and free organophosphite ligand from a homogeneous non-aqueous hydroformylation reaction mixture.

The present invention addresses the problems of the prior art.

Some aspects of the present invention are defined in the appended claims.

In one aspect the present invention provides a process for separating at least one PTA from an organic liquid mixture containing at least one organic solvent and at least one PTA, in which the organic liquid mixture is brought into contact with one surface of a selectively permeable membrane and pressure is applied to the organic liquid mixture which causes a fraction of the organic liquid to permeate through the membrane and exit at the other surface, such that the concentration of the at least one PTA in the fraction of organic liquid which does not permeate the membrane increases while the concentration of the at least one PTA in the fraction of organic liquid which permeates through the membrane is less than the concentration of the at least one PTA in the original mixture.

By the term “selectively permeable” it is meant a membrane which will allow the passage of solvent while retarding the passage of PTA, such that a PTA concentration difference can be produced by the solvent flow across the membrane. The term selectively permeable may be defined in terms of membrane rejection R, a common measure known by those skilled in the art and defined as:

$$R = ( 1 - \frac{{C}_{Pi}}{{C}_{Ri}} ) \times 100 \% \qquad ( 1 )$$

where C_{P,i}=concentration of species i in the permeate, permeate being the organic liquid which has passed through the membrane, and C_{R,i}=concentration of species i in the retentate, retentate being the organic liquid which has not passed through the membrane. It will be appreciated that a membrane is selectively permeable for a species if R>0.

By the term “phase transfer agent” (PTA) it is meant a chemical species which has two particular chemical functions in a biphasic reaction system: (i) it must rapidly transfer one of the reactant species into the normal phase of the other reactant and (ii) it must make the transferred species available in a reactive form. Such chemical species are well known to those skilled in the art, for example see Chapter 4 of Starks, Liotta and Halpern “Phase Transfer Catalysis—Fundamentals, Applications and Industrial Perspectives”.

By the term “organic solvent” it is meant an organic liquid in which the PTA is dissolved, such that the concentration of the PTA in the resultant mixture is substantially less than the concentration of the organic solvent in the mixture.

In a further aspect the present invention provides a process for separating at least one PTA from an organic liquid mixture containing at least one organic solvent, at least one other organic solute, and at least one PTA. The organic liquid mixture is bought into contact with one surface of a selectively permeable membrane and pressure is applied which causes a fraction of the organic liquid to permeate through the membrane such that the rejection of the at least one PTA is greater than 0%, and simultaneously the rejection of the at least one PTA is greater than the rejection of the at least one organic solute.

By the term “organic solute” it is meant an organic molecule, not a PTA, present in the organic liquid mixture.

In a further aspect the present invention provides for carrying out a PTC reaction comprising the steps of (a) carrying out a PTC reaction involving an organic liquid phase using at least one PTA which remains substantially dissolved in the organic liquid phase at the conclusion of the reaction; (b) separating the resulting phases at the conclusion of the reaction into organic liquid, aqueous and solid phases; (c) bringing the resulting organic liquid phase into contact with one surface of a selectively permeable membrane (d) applying pressure to cause a fraction of the organic liquid to permeate through the membrane such that the rejection of the PTA is greater than 0%.

In a further aspect the present invention provides for carrying out a PTC reaction comprising the steps of (a) carrying out a PTC reaction involving an organic liquid phase using at least one PTA which remains substantially dissolved in the organic liquid phase at the conclusion of the reaction; (b) separating the resulting phases at the conclusion of the reaction into organic liquid, aqueous and solid phases; (c) bringing the resulting organic liquid phase into contact with one surface of a selectively permeable membrane (d) applying pressure to cause a fraction of the organic liquid to permeate through the membrane such that the rejection of the PTA is greater than 0% (e) using the PTA-enriched organic liquid retentate as a constituent of an organic liquid phase in a further PTC reaction involving an organic liquid phase.

The PTC reaction in step (a) may be any PTC reaction known in the art. For example it may be an organic liquid-aqueous liquid PTC reaction, or a solid-organic liquid PTC reaction, or a solid-aqueous liquid-organic liquid PTC reaction.

It is understood that the phases to be separated in step (b) may be any two of organic liquid, aqueous liquid, or solid, or may be all three simultaneously. The phase separation in step (b) may be achieved by any means known in the art for phase separation, including settling and decantation, centrifugation, coalescence or in the case of PTC reactions involving solids, by a solids filtration which removes solid material without substantially changing the concentrations of dissolved species in the liquid phases.

In a further preferred embodiment, the organic liquid phase resulting from step (b) may undergo an intermediate washing step prior to step (c). This intermediate washing step may comprise mixing the organic liquid phase with water or any other solvent substantially immiscible with the organic liquid phase to extract specific species from the organic liquid phase, followed by a phase separation to separate the washing fluid and the organic liquid phase. By way of non-limiting example, the organic liquid phase may be washed with water to remove species such as solid salts, acids and bases, or ionic material. In yet a further preferred embodiment, at least one PTA present in the organic liquid undergoing the washing stage will stay substantially dissolved in the organic liquid phase during the washing process.

In a further aspect the present invention provides for carrying out a PTC reaction comprising the steps of (a) carrying out a PTC reaction involving an organic liquid phase using at least one PTA which remains substantially dissolved in the organic liquid phase at the conclusion of the reaction; (b) separating the resulting phases at the conclusion of the reaction into organic liquid, aqueous and solid phases; (c) bringing the resulting organic liquid phase into contact with one surface of a selectively permeable membrane (d) applying pressure to cause a fraction of the organic liquid to permeate through the membrane such that the rejection of the PTA is greater than 0% (f) processing the PTA-enriched organic liquid retentate to recover the PTA.

In step (f), the processing may include evaporation, extraction, distillation, ion exchange or any other process for PTA recovery known to those skilled in the art such as those based on differential solubilities described in U.S. Pat. No. 5,675,029.

We have found that in some cases during the membrane separation stage (d) the PTA can attach itself loosely to the membrane surface. In these cases it can be readily washed off using fresh organic liquid phase. In this respect a further aspect of the present invention provides for carrying out a PTC reaction comprising the steps of (a) carrying out a PTC reaction involving an organic liquid phase using at least one PTA which remains substantially dissolved in the organic liquid phase at the conclusion of the reaction; (b) separating the resulting phases at the conclusion of the reaction into organic liquid, aqueous and solid phases; (c) bringing the resulting organic liquid phase into contact with one surface of a selectively permeable membrane (d) applying pressure to cause a fraction of the organic liquid to permeate through the membrane such that the rejection of the PTA is greater than 0% (g) removing the organic liquid retentate from contact with the membrane (h) passing a fresh organic liquid over the surface of the membrane to solubilise any PTA attached to the membrane surface (i) using the organic liquids from steps (g) or (h), individually or mixed together, as constituents of the organic liquid phase in a further PTC reaction involving an organic liquid phase.

It is further understood that the organic liquid phases resulting from steps (g) and (h) may be further processed, either individually or mixed together, to recover the PTA contained therein.

Phase transfer catalytic reactions to which the present process can be applied are numerous and include by way of non-limiting examples such reactions as nucleophilic substitution reactions, displacement reactions, elimination reactions, halogen exchange reactions, fluorination reactions, ester formation reactions, ether formation reactions, alkylation reactions including C-alkylation, N-alkylation, S-alkylation, O-alkylation oxidation reactions, reduction reactions, carbene reactions, reactions containing transition metals as co-catalysts, and reactions producing products with chiral centres.

PTAs suitable for use in the present invention are numerous and include by way of non limiting examples:

(i) quaternary ammonium salts described by the following formula:

[R¹R²R³R⁴N]⁺Z⁻

(ii) quaternary phosphonium salts described by the following formula:

[R¹R²R³R⁴P]⁺Z⁻

where R¹-R⁴, which can be the same or different, are selected from C₁-C₁₀ organic radicals or groups, preferably C₁-C₁₀ aliphatic linear, branched or cyclic or aromatic groups, and Z⁻ is an anion preferentially selected from a halide (chloride, fluoride, bromide, iodide), cyanide, azide, thiocyanate, sulfate, hydrogen sulfate, alkyl sulfate (e.g. ethosulfate), alkoxide or aryloxy (e.g. phenoxy). Examples of preferred PTAs include by way of non-limiting example tetrabutylammonium bromide, tetraoctylammonium bromide, bezyltripropylammonium chloride, tetrabutylphosphonium bromide, tetraoctylphosphonium bromide, tetraphenylphosphonium bromide and combinations thereof.

(ii) macrocyclic polyethers (crown ethers) such as by way of non-limiting example dibenzo-18-crown-6; 15-crown-5,18-crown-6; dibenzo-21-crown-7; dibenzo-24-crown-8

(iv) aza-macrobicyclic ethers (cryptands) such as by way of non-limiting example 4,7,13,1616,21,24-Hexaoxa-1,10-diazabicylco[8.8.8] hexacosane (also known as Kryptofix 222); 6,6-Benzo-4,7-13,16,21,24-hexaoxa-1,10-diaza-bicylco [8.8.8] hexacosane (also known as Kryptofix 222B)

(v) Polyethylene glycols (PEGs) and substituted PEGs

(vi) 4-aminopyridine derivatives and hexaalkylguanadinium salts

Preferably the PTA will have a molecular weight of above 200; yet more preferably above 300, and yet more preferably above 400.

The organic liquid phase used in the phase transfer reaction will preferably comprise an inert solvent in which one or more reactants and one or more PTAs is dissolved or suspended. It will be chosen with regard to solubility of reactants, reaction rate, and required reaction temperature among other factors such as cost and safety. Suitable inert solvents are numerous and well know to those skilled in the art. By way of non-limiting example, suitable solvents include aromatics, ketones, chlorinated solvents, esters, ethers, and dipolar aprotic solvents including toluene, xylene, benzene, chlorobenzene, dichlorobenzene, chloroform, dichloromethane, ethyl acetate, methyl ether ketone (MEK), methyl iso butyl ketone (MIBK), adiponitrile, dimethyl fomamide, dimethylsulfoxide, tetrahydrofuran, dimethoxyethane and sulfolane.

In yet another preferred embodiment one of the reactants for the system will be chosen to act as the solvent in which the reaction is performed.

The membrane of the present invention can be configured in accordance with any of the designs known to those skilled in the art, such as spiral wound, plate and frame, shell and tube, hollow fibre or derivative designs thereof. The membranes may be of cylindrical or planar geometry.

The membrane of the present invention may be a porous or a non-porous membrane. Suitable membranes will have a rejection for the at least one PTA greater than 0%, yet more preferably greater than 40%, yet more preferably greater than 70%, yet more preferably greater than 90% and yet more preferably greater than 99%.

Preferably the membrane of the present invention will have a rejection for the at least one PTA which is greater than the rejection for at least one of the PTC reaction products. Yet more preferably, the membrane will be able to separate PTAs with molecular weights greater than 200 Daltons from products with molecular weights less than 200 Daltons. Yet more preferably the membrane will be able to separate PTAs with molecular weights greater than 300 Daltons from products with molecular weights less than 300 Daltons. Yet more preferably the membrane will be able to separate PTAs with molecular weights greater than 400 Daltons from products with molecular weights less than 400 Daltons.

The membrane of the present invention may be formed from any polymeric or ceramic material which provides a separating layer capable of separating the PTA from the organic solvent. Preferably the membrane is formed from or comprises a material selected from polymeric material suitable for fabricating microfiltration, ultrafiltration, nanofiltration or reverse osmosis membranes, including polyethylene, polypropylene, polytetrafluoroethylene (PTFE), polyvinylidene difluoride (PVDF), polyethersulfone, polyacrylonitrile, polyamide, polyimide, cellulose acetate, and mixtures thereof.

In a preferred aspect the membrane consists essentially of a polyimide polymer based on any of the following

(i) a polymer based on 5(6)-amino-1-(4′-aminophenyl)-1,3-trimethylindane and benzophenone tetracarboxylic acid;

(ii) a polymer with 1 (or 3)-(4-aminophenyl)-2,3-dihydro-1,3,3 (or 1,1,3)-trimethyl-1H-inden-5-amine and 5,5′-carbonylbis-1,3-isobenzofurandione;

(iii) a copolymer derived from the co-condensation of benzophenone 3,3′,4,4′-tetracarboxylic acid dianhydride and a mixture of di(4-aminophenyl) methane and toluene diamine of the corresponding diisocyanates, 4,4′-methylenebis(phenyl isocyanate) and toluene diisocyanate; and

(iv) a copolymer derived from the co-condensation of 1H,3H-Benzo[1,2-c:4,5-c′] difuran-1,3,5,7-tetrone with 5,5′-carbonylbis[1,3-isobenzofurandione], 1,3-diisocyanato-2-methylbenzene and 2,4-diisocyanato-1-methylbenzene.

The membranes can be made by any technique known to the art, including sintering, stretching, track etching, template leaching, interfacial polymerisation or phase inversion. Yet more preferably the membrane is prepared from a ceramic material such as by way of non-limiting example silicon carbide, silicon oxide, zirconium oxide, titanium oxide, or zeolites, using any technique known to those skilled in the art such as sintering, leaching or sol-gel processes.

Preferably the selectively permeable membrane is a composite membrane.

In a preferred aspect the membrane is non-porous and the non-porous, selectively permeable layer thereof is formed from or comprises a material selected from modified polysiloxane based elastomers including polydimethylsiloxane (PDMS) based elastomers, ethylene-propylene diene (EPDM) based elastomers, polynorbornene based elastomers, polyoctenamer based elastomers, polyurethane based elastomers, butadiene and nitrile butadiene rubber based elastomers, natural rubber, butyl rubber based elastomers, polychloroprene (Neoprene) based elastomers, epichlorohydrin elastomers, polyacrylate elastomers, polyethylene, polypropylene, polytetrafluoroethylene (PTFE), polyvinylidene difluoride (PVDF), and mixtures thereof.

In a preferred aspect the membrane comprises a reinforcing material selected from an external mesh and support. This is particularly advantageous for homogenous tubes or sheets. Such tubes or sheets may be reinforced to increase their burst pressure, for example by overbraiding tubes using fibres of metal or plastic, or by providing a supporting mesh for flat sheets.

When the membrane comprises a non-porous layer and an additional component, the additional component may be a supporting layer. The supporting layer may be a porous support layer. Suitable materials for the open porous support structure are well known to those skilled in the art of membrane processing. Preferably the porous support is formed from or comprises a material selected from polymeric material suitable for fabricating microfiltration, ultrafiltration, nanofiltration or reverse osmosis membranes, including polyethylene, polypropylene, polytetrafluoroethylene (PTFE), polyvinylidene difluoride (PVDF), polyethersulfone, polyacrylonitrile, polyamide, polyimide, cellulose acetate and mixtures thereof.

Selectively permeable membranes useful for the present invention can are disclosed in U.S. Pat. Nos. 5,205,934; 5,265,734; 4,985,138; 5,093,002; 5,102,551; 4,748,288; 4,990,275; 4,368,112 and 5,067,970. Preferred membranes are produced by WR Grace & Co and are described in U.S. Pat. No. 5,624,166 and WO 00/06293.

The rejection performance of the membrane may be found ot be improved by pre-soaking the membrane in the solvent to be used in the reaction. The rejection and the flux may be advantageously manipulated by working at temperatures either above or below ambient when carrying out the membrane separation.

The process may be performed in a continuous, semi-continuous or discontinuous (batch mode) manner. In the latter aspect the flow of at least one of the organic liquid phase, or an aqueous fluid, or a solid is discontinuous.

In some cases it may be necessary to cool the organic liquid from step (a) or (b) prior to contact with the membrane in step (c), while in other cases it may be necessary to heat the organic liquid prior to step (c).

Typically in PTC reactions the ratio of the PTA to the reactants on a molar percentage basis is between 5-10 mol %. In some cases higher ratios of PTA can increase the reaction rate but are not used due to the cost of the PTA and the difficulty of separating it from the organic liquid mixture. It is clear that in the present invention, whose objective is PTA separation and in some cases also re-use, that these constraints on PTA concentration are not as important and it can be practical to work with PTA to reactant ratios in excess of 10%, and more preferably in excess of 20%.

The ratio of PTA to at least one reactant in the organic liquid phase on a molar percentage basis is preferably in the range 0.1-200 mol %, more preferably 1-20 mol %.

The process may be performed in the presence of a transition metal co-catalyst which is retained by the selectively permeable membrane.

The invention will now be described in further detail in the following non-limiting Examples.

### EXAMPLES

### Example 1

The solvent flux and PTA rejection of various membranes is demonstrated in this example. Membranes selected for this study are listed in Table 1, showing membrane properties.

TABLE 1
Solvent stable NF Membranes: Manufacturers Data

| | Membrane | MW | Membrane | | Flux (L/m² h) |
|---|---|---|---|---|---|
| Manufacturer | type | cutoff | property | Rejection (%) | Toluene |
| Koch | MPF-44 | 250 | hydrophilic | 98 (5% Sucrose, MW = 342, in | — |
| (USA) | | | | water) | |
| | MPF-50 | 700 | Hydrophobic | 70 (Sudan IV, MW = 384, in | 30 |
| | | | | ethyl acetate) | |
| | MPF-60 | 400 | Hydrophobic | 90 (Sudan IV, MW = 384, in | 18 |
| | | | | ethyl acetate) | |
| Osmonics | Desal-5 | 350 | Hydrophilic | 96 (Sucrose, MW = 342, in | — |
| (USA) | | | | water) | |
| WR Grace | 142A | 220 | Hydrophobic | 62 (2% n-decane, MW = 142, in | 35 (54 bar) |
| (USA) | | | | toluene) | |
| | 142B | 200 | Hydrophobic | 74 (2% n-decane, MW = 142, in | 20 (54 bar) |
| | | | | toluene) | |
| | 142C | 400 | Hydrophobic | 28 (2% n-decane, MW = 142, in | 19 (54 bar) |
| | | | | toluene) | |

MPF membranes were supplied soaked in a solution of 0.7% Roccal for MPF-44 and 50% ethanol/water for MPF-50 and MPF-60. According to the manufacturer's data sheets these membranes should under no circumstances be allowed to dry out since this 20 adversely affects their performance. Desal-5 series membranes were supplied in a dry form; 142 series membranes were supplied loaded with a conditioning agent which was easily washed out with solvent. Non-porous silicone rubber (Silex Ltd, U.K.) and EPDM (ethylene propylene diene terpolymer, William Warne Ltd., U.K.) membranes were tested in addition to the materials shown in Table 1. The thickness of both the silicone rubber and EPDM membranes was about 0.6 mm.

Retention and fluxes were determined using an Osmonics/Desal (USA) SEPA-ST test cell Membrane discs were cut from A4 sheets in circular discs 49 mm in diameter, giving an active membrane area of 16.9 cm². All experiments were carried out in a fume cupboard at room temperature (18-20° C.). The cell was pressurised with compressed nitrogen gas at pressures of 5-50 bar. The volume of feed solution ranged from 50 to 300 mL and the volume of permeate was measured with a measuring cylinder. The solvent flux (J) was obtained by

$$J = \frac{V}{At} \qquad ( 2 )$$

where V is the volume of permeate (solvent), A is membrane area and t is time.

Two PTAs were used to evaluate rejection, tetrabutylammonium bromide (TBABr), MW=322 and tetraoctylammonium bromide (TOABr) MW=546. For experiments used to determine PTA rejection, the solution was stirred with a teflon coated magnetic stirrer bar at 300 rpm and when half the volume of the feed solution permeated the membrane the experiment was stopped. The concentrations of PTAs in permeate and retentate were measured using gas chromatography. The rejection was calculated by

$$R = ( 1 - \frac{{C}_{P}}{{C}_{R}} ) \times 100 \% \qquad ( 3 )$$

where C_{P} and C_{R} are the final concentrations in the permeate and retentate, respectively. The initial PTA concentration in solvent was 0.05M unless otherwise specified. Repeated rejection experiments had a coefficient of variation of 10%. For all rejection experiments, a mass balance was calculated to check whether material was lost by sticking to the membrane or cell. This was calculated as:

$$MB = ( \frac{{C}_{P} {V}_{P} + {C}_{R} {V}_{R}}{{C}_{I} {V}_{I}} ) \times 100 \% \qquad ( 4 )$$

where V_{P}, V_{R}, V_{I} are volume of permeate, retentate and the initial solution, respectively, C_{I} is the PTA concentration in initial solution.

Table 2 shows data for membrane flux of toluene with no added PTA; Table 3 shows flux and retention data for toluene with 0.05M TOABr and TBABr. The mass balance was between 80-102% for all experiments with PTA. In cases with mass balances lower than 100%, catalyst has clearly disappeared from the liquid phase. In some runs an apparent accumulation of a layer of material on the membranes after use was noted, and it is assumed that this was the unaccounted for catalyst.

TABLE 2
Toluene fluxes at 30 bar

| | | | | | | | | Silicone | |
|---|---|---|---|---|---|---|---|---|---|
| Membrane | Desal-5 | MPF-44 | MPF-50 | MPF-60 | 142A | 142B | 142C | rubber | EPDM |
| MWCO | 350 | 250 | 700 | 400 | 220 | 200 | 400 | — | — |
| Flux | 6 | <0.1 | 21 | 5 | 39 | 34 | 38 | 0.8 | 0.3 |
| (L m⁻² h⁻¹) | | | | | | | | | |

TABLE 3
Solvent fluxes and catalyst retention by NF and non-porous membranes at 30 bar

| | | Toluene / TBABr (MW = 322) | | Toluene / TOABr (MW = 546) | |
|---|---|---|---|---|---|
| Membrane | MWCO | Flux (L m⁻² h⁻¹) | Rejection (%) | Flux (L m⁻² h⁻¹) | Rejection (%) |
| MPF-50 | 700 | 19 | 61 | 19 | 48 |
| MPF-60 | 400 | 5 | 89 | 2 | 86 |
| Desal-5 | 350 | 3 | 55 | 4 | 62 |
| 142A | 220 | 23 | >99 | 26 | >99 |
| 142B | 200 | 20 | >99 | 24 | >99 |
| 142C | 400 | 28 | 80 | 16 | >99 |
| Silicone rubber | — | 0.3 | >99 | 0.2 | >99 |
| EPDM rubber | — | 0.2 | >99 | 0.2 | >99 |

The flux decreased by 20-65% in the presence of 0.05M PTA in the toluene solution. The permeate flux of 0.05 M TOABr-toluene (200 ml) through 142B in three consecutive runs was 23.7, 15.9, 18.4 L m⁻² h⁻¹ (rejection>99%) compared to a pure toluene flux of 40 L m⁻² h⁻¹, ie the flux was reduced by 40-60% when TOABr was present.

The retention of 0.00M, 0.005M, 0.01M TBABr in toluene using Desal-5 membrane was 71, 77, 80%, respectively ie in this case the retention increases slightly with increasing catalyst concentration.

The data shows that all of these membranes are suitable for use in the present invention.

### Example 2

Further membrane rejection tests were undertaken using a phosphonium salt, tetrabutylphosphonium bromide (TBPBr), at a concentration of 0.05M in m-dichlorobenzene as a solvent. Phosphonium quats are known in the art to be useful for catalysing PTC reactions, and have been used at elevated temperatures (greater than 120° C.) for catalysing flourination reactions. Under these conditions a solvent such as m-dichlorobenzene, which has a boiling point of 172° C. at atmospheric pressure, or adiponitrile, which has a boiling point of 295° C. at atmospheric pressure, are preferred.

Concentrations of TOPBr were determined by partitioning a fraction of the TOPBr into water and measuring the Total Organic Carbon concentration in the water. The rejection of TOPBr by 142 A was found to be 78%. Thus this membrane is suitable for use in the present invention.

### Example 3

The present invention was applied to the PTC reaction below:

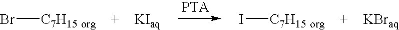

where the subscripts org and aq denote the organic solvent and aqueous phases, respectively. The reaction involves the conversion of bromoheptane into iodoheptane using an aqueous phase of potassium iodide and is a classic example of a nucleophilic, aliphatic substitution reaction. Toluene, a common solvent in industry and a typical solvent used in phase-transfer catalysis, was used as the organic solvent in this reaction. Typically, phase transfer catalysts are classified as hydrophilic or lipophilic. Two commonly used PTCs, which both catalyse the above reaction, are tetrabutylammonium bromide (TBABr, hydrophilic) and tetraoctylammonium bromide (TOABr, lipophilic). The solubilities of TBABr in water and toluene, and TOABr in toluene were measured as 600 g/L, 1.6 g/L and 380 g/L respectively (TOABr is virtually insoluble in water). At the end of the reaction, the lipophilic TOABr partitions entirely into the organic product mixture in the organic phase. Hydrophilic TBABr also partitions into the organic product mixture due to the salting-out effect exerted by the KI (the 2M KI concentration corresponds to about 33 wt % KI in water).

The reaction was carried out in a glass vessel of 100 mL with a 40 mL aqueous phase (2M KI) and 40 mL organic phase (0.5M bromoheptane+0.05 M TOABr in toluene, ie a catalyst molar loading of 10%). The temperature was 50° C. and stirring speed was 400 rpm. After the reaction was completed, the organic phase (40 mL) was transferred into the SEPA ST cell of Example 1 and the cell was pressurized at 30 bar at room temperature. After 35 mL of the 40 mL was filtered out, two different procedures were employed to reclaim the catalyst in the permeate and carry on the subsequent reactions:

CASE 1: The 5 ml of retentate left in the cell was washed out with pure toluene and the toluene was evaporated at 50° C. overnight in a fume cupboard. This catalyst was then added to 40 mL 0.5 M bromoheptane in toluene (no other TOABr added) and mixed with 40 mL of 0.5 M KI aqueous phase. The reaction and nanofiltration were carried out as described above. In CASE 1 a new membrane disc was used for the separation of the TOABr each time. The reaction was carried out three times using the same catalyst.

CASE 2: The 5 ml of retentate left in the cell was washed out with 35 mL of 0.5M bromoheptane in toluene to form the organic phase for the subsequent reaction. This organic phase was then mixed with 40 mL of 0.5 M KI aqueous phase. The reaction and nanofiltration were carried out as described above. In CASE 2 the same membrane disc was used in the repeated experiments, ie a single membrane disc was used for all three reactions.

The basic concept of this study is to retain the catalyst and recycle it while any products and residual reactants which are dissolved in the organic liquid phase at the conclusion of the reaction pass through the membrane.

Preliminary tests were used to demonstrate that the membrane employed could retain the TOABr while allowing the reactants and products present in the organic liquid mixture at the conclusion of the reaction to permeate the membrane.

Firstly, the retention of 0.01 M iodoheptane (MW=226) in toluene with 142A membrane was measured as 19.8% (mass balance=93%), permeate flux 35 L m⁻¹ h⁻¹. This preliminary test shows that the reaction product should be able to substantially pass through the membrane.

Separation of TOABr from a solution consisting of 0.01M bromoheptane, 0.01M iodoheptane and 0.01M TOABr in toluene using 142A and 142C membranes is summarised in Table 4.

TABLE 4
Separation of catalyst from a synthetic solution
[Br—C₇H₁₅ (0.01 M) + I—C₇H₁₅ (0.01
M) + TOABr (0.01 M) + Toluene]

| | | Flux | | Rejection (%) | | |
|---|---|---|---|---|---|---|
| Mem- | | (L m⁻² h⁻¹) | | Br—C₇H₁₅ | I—C₇H₁₅ | TOABr |
| brane | MWCO | Pure | Solution | (MW179) | (MW226) | (MW546) |
| 142A | 220 | 65 | 25 | 20 | 22 | >99 |
| 142C | 400 | 88 | 32 | 8 | 5 | >99 |

The rejections of the reactant bromoheptane (MW=179), the product iodoheptane (MW=226), and the catalyst TOABr (MW=546) were 20%, 22%, and >99% respectively using 142A and 8%, 5%, and >99% using 142C, respectively. The toluene flux was 25 L m⁻² h⁻¹ for 142A and 32 L m⁻² h⁻¹ for 142C. This shows that it should be possible to allow the residual reactant and product to pass through either membrane, while retaining the catalyst for re-use.

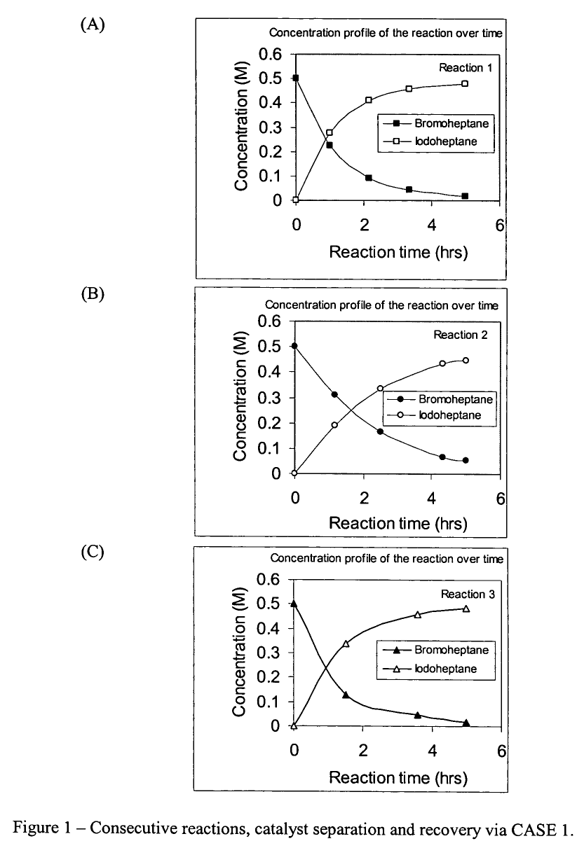

The evolution of the reactant (bromoheptane) and product (iodoheptane) during a series of reactions where catalyst separation and recovery was as per CASE 1, is shown in FIG. 1. After 5 hours in the first reaction, the bromoheptane was converted to iodoheptane with a conversion>95% in the presence of TOABr. The reaction mixture (40 mL) was filtered through 142A and the reaction was repeated. The conversion of bromoheptane within 5 hours in the two consecutive reactions was greater than 90% (FIGS. 11B and 1C), indicating that the catalyst was separated and recycled without any loss of activity.

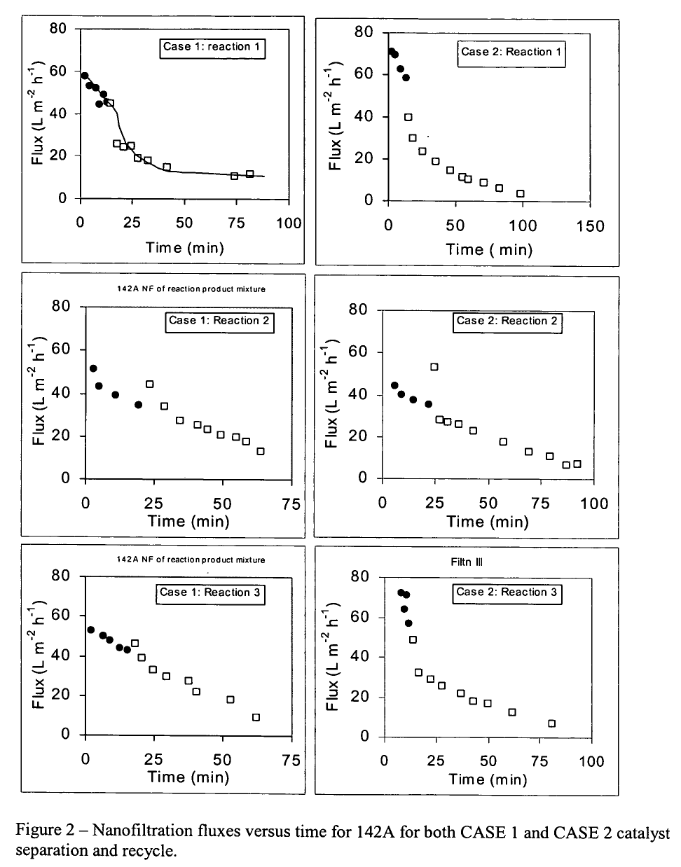

Similar data were obtained in a second reaction cycle with catalyst recovery as per CASE 2. Flux data for the two reaction cycles is shown in FIG. 2, and data for both reaction and nanofiltration is summarised in Table 5. A control experiment confirmed no conversion of bromoheptane was observed in 6 hours in the absence of TOABr.

TABLE 5
Example 3 - Reaction followed by separation of PTA from reaction
product mixture by 142A (MWCO = 220) membrane

| | Reaction | | | Solution flux | | Rejection (%) | | | | | |
|---|---|---|---|---|---|---|---|---|---|---|---|
| | time | Conversion (%) | | (L m⁻² h⁻¹) | | TOABr (546) | | I—C₇H₁₅ (226) | | Br—C₇H₁₅ (179) | |
| Reaction | (hrs) | Case 1 | Case 2 | Case 1 | Case 2 | Case 1 | Case 2 | Case 1 | Case 2 | Case 1 | Case 2 |
| 1 | 5 | 97 | 98 | 12 | 9.1 | >99 | >99 | 12 | 11 | 10 | 11 |
| 2 | 5 | 90 | 97 | 14 | 8.5 | >99 | >99 | 18 | 15 | 14 | 18 |
| 3 | 5 | 96 | 96 | 15 | 7.0 | >99 | >99 | 5 | 8 | 13 | 7 |

Case 1: the 5 ml of retentate was washed out with pure toluene and then recovered by toluene evaporation; each filtration was carried out with a fresh membrane disc.

Case 2: the retentate was washed out each time with fresh organic reactant solution containing no catalyst, and consecutive filtrations were carried out with the same membrane disc.

The permeate flux of the reaction mixture decreased to between 7 and 15 L m⁻² h⁻¹ at the end of the nanofiltration step, where TOABr was thought to precipitate out of the solution and stick to the membrane surface. The solubility of TOABr in toluene is 380 g/L, and the starting concentration in the reaction mixture is 27 g/L, so it is expected that after 35 mL of organic phase has been removed a maximum concentration of 218 g/L could result. This should be below the solubility limit of TOABr in toluene. However, it is possible that effects of the counter ion and the reactant/product in the system lower the TOABr solubility, causing the catalyst to come out of solution at the membrane surface.

For both reaction and filtration, CASE 1 and CASE 2 gave similar results with no noticeable difference. In CASE 2, (in which the same membrane disc was used for all filtrations) the membrane is effectively “washed” at the end of each filtration with the reaction mixture going into the next batch. It appears that this simple washing procedure is sufficient to restore flux, as each successive filtration starts at fluxes above 40 L m⁻² h⁻¹. This suggests that the decrease in flux is probably due to catalyst which precipitates out on the surface of the membrane, possibly due to catalyst concentration rising above the solubility of catalyst in the liquid under the prevailing conditions. It is an advantageous feature of the present invention that this flux can be restored, and the catalyst reclaimed, by simple washing with the reaction solvent.

In both CASE 1 and CASE 2, the TOABr is rejected more than 99%. This corresponds to effectively all the catalyst being separated after each reaction. In both cases, the subsequent reactions were carried out using only the initial portion of catalyst which was added to reaction 1.

### Example 4

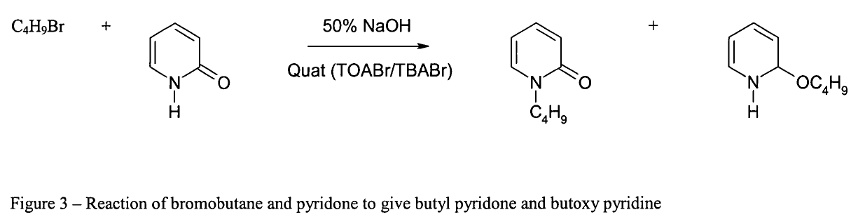

The present invention was applied to the PTC reaction shown in FIG. 3. The reaction involves the conversion of 2-pyridone into 2-butoxypyridine and N-butyl-2-pyridone using an aqueous phase comprising 50 wt % NaOH. This is an example of a base catalysed N-alkylation reaction in which an O-alkylation reaction also occurs. Toluene, a common solvent in industry and a typical solvent used in phase-transfer catalysis, was used as the organic solvent in this reaction. Typically, phase transfer catalysts are classified as hydrophilic or lipophilic. Two commonly used PTCs, which both catalyse the above reaction, are tetrabutylammonium bromide (TBABr, hydrophilic) and tetraoctylammonium bromide (TOABr, lipophilic). The solubilities of TBABr in water and toluene, and TOABr in toluene were measured as 600 g/L, 1.6 g/L and 380 g/L respectively (TOABr is virtually insoluble in water). At the end of the reaction, the lipophilic TOABr partitions entirely into the organic product mixture in the organic phase. Hydrophilic TBABr also partitions into the organic product mixture due to the salting-out effect exerted by the 50 wt % NaOH. In preliminary experiments it was found that TOABr provides a higher conversion into N-butyl-2-pyridone (the product of the N-alkylation) than TBABr, and TOABr was used in subsequent experiments.

The reaction was carried out in a glass vessel of 100 mL with a 4 mL aqueous phase (50 wt % NaOH) and 40 mL organic phase (0.1M 2-pyridone, 0.2M butyl bromide, 0.01 M TOABr in toluene, ie a 10% catalyst loading on a molar basis). The temperature was 60° C. and stirring speed was 400 rpm. After the reaction was completed, the aqueous phase was separated from the organic phase by centrifugation. The organic phase (40 mL) was then washed with water (40 mL) to remove traces of NaOH. The wash water was separated from the organic liquid phase which was then transferred into the SEPA cell of Example 1. The cell was pressurized to 30 bar at room temperature and 35 mL of the 40 mL organic phase was filtered out. The 5 ml of retentate left in the cell was washed out with 35 mL of 0.1M 2-pyridone 0.2M butyl bromide in toluene. This organic liquid formed the organic phase for the subsequent reaction. The organic liquid was then mixed with 4 mL of 50 wt % NaOH aqueous phase. The reaction and separation were carried out as described above, until three reactions and three filtrations had been completed. The same membrane disc was used in the repeated experiments, ie a single membrane disc was used for all three filtrations.

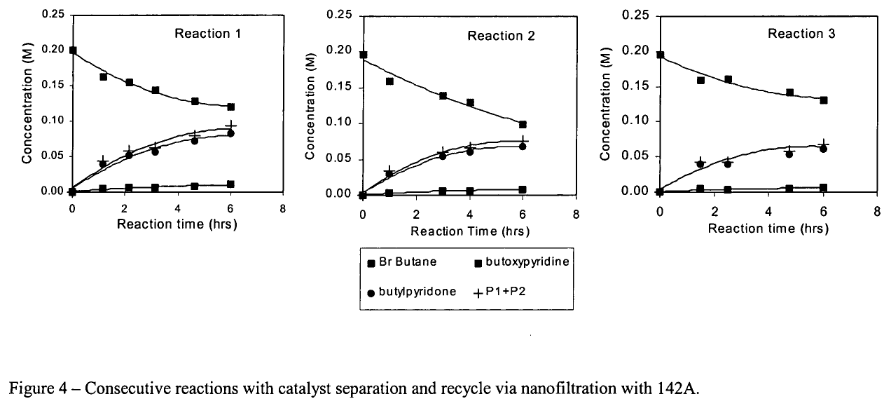

The results are shown in FIG. 4, and Table 6.

TABLE 6
Example 4 - Reaction followed by separation of PTA from reaction
product mixture by 142A (MWCO = 220) membrane

| | Reaction | | Solution | Rejection (%) | | |
|---|---|---|---|---|---|---|
| | time | Conversion | flux | TOABr | 2-Butoxypyridine | N-Butyl 2-pyridone |
| | (hrs) | (%) | (Lm⁻²h⁻¹) | (MW = 546) | (MW = 151) | (MW = 151) |
| Reaction 1 | 6 | 99 | 21 | >99 | 12 | 16 |
| Reaction 2 | 6 | 99 | 21 | >99 | 9 | 10 |
| Reaction 3 | 6 | 89 | 19 | >99 | 11 | 12 |

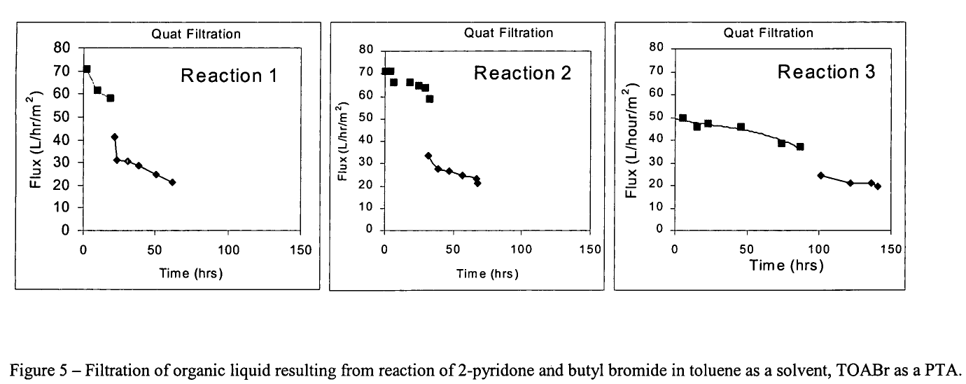

High conversions are obtained in the three consecutive reactions. FIG. 5 shows the filtration flux versus time for the three consecutive filtrations. While the flux appears to fall during each filtration, flux is recovered by washing the membrane with the fresh reaction mixture.

All publications mentioned in the above specification are herein incorporated by reference. Various modifications and variations of the described methods and system of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention which are obvious to those skilled in chemistry or related fields are intended to be within the scope of the following claims.

1. A process for separating a phase transfer agent (PTA) from a liquid composition comprising an organic solvent and the PTA, the process comprising the steps of
(i) providing a selectively permeable membrane having a first surface and a second surface
(ii) transferring a portion of the organic solvent and optionally a portion of the PTA from the first surface to the second surface across the membrane by contacting the composition with the first surface, wherein pressure at the first surface is greater than pressure at the second surface, and wherein the membrane is a selectively permeable membrane such that the membrane rejection (R) of the PTA is greater than 0%.

2. A process according to claim 1 wherein the composition further comprises an organic solute.

3. A process according to claim 2 wherein the membrane is a selectively permeable membrane such that the rate of transfer of the organic solute across the membrane relative to its concentration at the first surface is higher than the rate of transfer of the PTA across the membrane relative to its concentration at the first surface.

4. A process according to claim 2 or 3 wherein the organic solute is the product from a reaction catalysed by the PTA.

5. A process according to any one of the preceding claims wherein prior to step (ii) the process comprising the step of
(a) performing a phase transfer catalysis (PTC) reaction involving the liquid composition comprising the organic solvent and the PTA, wherein the PTA remains substantially dissolved in the organic solvent at the conclusion of the reaction; and
(b) at the conclusion of the reaction separating the resulting phases into the liquid composition of step (ii), an aqueous phase and a solid phase.

6. A process according to any one of the preceding claims further comprising the step of utilising the organic solvent and PTA retained at the first surface of the membrane in a PTC reaction.

7. A process according to claim 5 further comprising the step of recycling the organic solvent and PTA retained at the first surface of the membrane to the PTC reaction of step (a).

8. A process according to any one of the preceding claims further comprising the step of collecting the organic solvent and PTA retained at the first surface of the membrane and recovering the PTA.

9. A process according to claim 8 wherein the recovery utilises evaporation, extraction, distillation, ion exchange and/or differential solubility.

10. A process according to claim 8 or 9 comprising the further step of subsequently using the recovered PTA to catalyse a PTC reaction.

11. A process according to any one of the preceding claims comprising the step of collecting the organic solvent and optionally PTA retained at the first surface of the membrane and passing a further organic solvent over the first surface of the membrane to solubilise any PTA attached to the membrane surface.

12. A process according to claim 11 wherein organic solvent and optionally PTA collected at the first surface and/or the further organic solvent passed over the first surface and optionally PTA, individually or mixed together, is used as a constituent of the organic liquid phase in a PTC reaction.

13. A process according to claim 11 wherein organic solvent and optionally PTA collected at the first surface and/or the further organic solvent passed over the first surface and optionally PTA, individually or mixed together, is further processed to recover the PTA.

14. A process according to any one of claims 5 to 13 wherein liquid composition phase resulting from step (b) undergoes a washing step prior to step (i), the washing step comprising
mixing the composition with a solvent substantially immiscible with the composition to extract a specific species from the composition,
phase separation to separate the immiscible solvent and the composition, such that the PTA remains substantially dissolved in the composition.

15. A process according to claim 14 wherein the immiscible solvent is water.

16. A process according to claim 13 or 14 wherein the specific species is selected from solid salts, acids, bases, ionic material, and combinations thereof.

17. A process according to any one of claims 5 to 16 wherein the PTC reaction involves an organic liquid phase and an aqueous liquid phase.

18. A process according to any one of claims 5 to 17 wherein the PTC reaction involves an organic liquid phase and a solid phase.

19. A process according to claims 17 or 18 wherein the PTC reaction involves an organic liquid phase, an aqueous liquid phase, and a solid phase.

20. A process according to any one of claims 5 to 19 wherein the phase separation in step (b) is achieved through a method selected from settling and decantation, centrifugation, coalescence, and solids filtration such that solid material is removed without substantially changing the concentrations of dissolved species in the liquid phases.

21. A process according to any one of claims 5 to 20 wherein the composition after the PTC reaction of step (a) further comprises an organic solute.

22. A process according to any one of claims 5 to 21 wherein the PTC reaction is chosen from nucleophilic substitution reactions, displacement reactions, elimination reactions, halogen exchange reactions, fluorination reactions, ester formation reactions, ether formation reactions, alkylation reactions including C-alkylation, N-alkylation, S-alkylation, O-alkylation, oxidation reactions, reduction reactions, carbene reactions, reactions containing transition metals as co-catalysts, reactions producing products with chiral centres and combinations thereof.

23. A process according to any one of the preceding claims wherein the PTA is selected from:
(i) quaternary ammonium salts of the formula:
[R¹R²R³R⁴N]⁺Z⁻
(ii) quaternary phosphonium salts of the formula:
[R¹R²R³R⁴P]⁺Z⁻
where R¹-R⁴, which can be the same or different, are selected from C₁-C₁₀ organic radicals or groups, preferably C₁-C₁₀ aliphatic linear, branched or cyclic or aromatic groups, and
Z⁻ is an anion selected from a halide, cyanide, azide, thiocyanate, sulfate, hydrogen sulfate, alklyl sulfate, alkoxide and aryloxy
(iii) macrocyclic polyethers (crown ethers) preferably dibenzo-18-crown-6; 15-crown-5, 18-crown-6; dibenzo-21-crown-7; or dibenzo-24-crown-8
(iv) aza-macrobicyclic ethers (cryptands) preferably 4,7,13,16,16,21,24-Hexaoxa-1,10-diazabicylco[8.8.8]hexacosane (Kryptofix 222); 6,6-Benzo-4,7-13,16,21,24-hexaoxa-1,10-diaza-bicylco [8.8.8]hexacosane (Kryptofix 222B)
(v) polyethylene glycols (PEGs) and substituted PEGs
(vi) 4-aminopyridine derivatives and hexaalkylguanadinium salts

24. A process according to claim 23 wherein the PTA is selected from tetrabutylammonium bromide, tetraoctylammonium bromide, bezyltripropylammonium chloride, tetrabutylphosphonium bromide, tetraoctylphosphonium bromide, tetraphenylphosphonium bromide and combinations thereof.

25. A process according to any one of the preceding claims wherein the PTA has a molecular weight above 200 Daltons.

26. A process according to any one of the preceding claims wherein the PTA has a molecular weight above 300 Daltons.

27. A process according to any one of the preceding claims wherein the PTA has a molecular weight above 400 Daltons.

28. A process according to any one of the preceding claims wherein the organic solvent is selected from aromatics, ketones, chlorinated solvents, esters, ethers, and dipolar aprotic solvents.

29. A process according to any one of the preceding claims wherein the organic solvent is selected from toluene, xylene, benzene, chlorobenzene, dichlorobenzene, chloroform, dichloromethane, ethyl acetate, methyl ether ketone (MEK), methyl iso butyl ketone (MIBK), adiponitrile, dimethylfomamide, dimethylsulfoxide, tetrahydrofuran, and dimethoxyethane and sulfolane.

30. A process according to any one of claims 5 to 29 wherein the organic solvent acts as a reactant in the PTC reaction.

31. A process according to any one of the preceding claims wherein the selectively permeable membrane has cylindrical or planar geometry and is configured as spiral wound, plate and frame, shell and tube, hollow fibre, or derivative designs thereof.

32. A process according to any one of claims 5 to 31 wherein the membrane has a rejection for the PTA which is greater than the rejection for a PTC reaction product dissolved in the composition.

33. A process according to any one of the preceding claims wherein the selectively permeable membrane separates PTA with molecular weight greater than 200 Daltons from PTC reaction product with molecular weights less than 200 Daltons.

34. A process according to any one of the preceding claims wherein the selectively permeable membrane separates PTA with molecular weight greater than 300 Daltons from PTC reaction product with molecular weights less than 300 Daltons.

35. A process according to any one of the preceding claims wherein the selectively permeable membrane separates PTA with molecular weight greater than 400 Daltons from PTC reaction product with molecular weights less than 400 Daltons.

36. A process according to any one of the preceding claims wherein the selectively permeable membrane comprises or is formed from a polymeric material or a ceramic material.

37. A process according to any one of the preceding claims wherein the selectively permeable membrane is formed from or comprises a material selected from polymeric material suitable for fabricating microfiltration, ultrafiltration, nanofiltration or reverse osmosis membranes, including polyethylene, polypropylene, polytetrafluoroethylene (PTFE), polyvinylidene difluoride (PVDF), polyethersulfone, polyacrylonitrile, polyamide, polyimide, cellulose acetate, and mixtures thereof.

38. A process according to any one of the preceding claims wherein the membrane consists essentially of a polyimide polymer based on any of the following
(i) a polymer based on 5(6)-amino-1-(4′-aminophenyl)-1,3-trimethylindane and benzophenone tetracarboxylic acid;
(ii) a polymer with 1 (or 3)-(4-aminophenyl)-2,3-dihydro-1,3,3 (or 1,1,3)-trimethyl-1H-inden-5-amine and 5,5′-carbonylbis-1,3-isobenzofurandione;
(iii) a copolymer derived from the co-condensation of benzophenone 3,3′,4,4′-tetracarboxylic acid dianhydride and a mixture of di(4-aminophenyl) methane and toluene diamine of the corresponding diisocyanates, 4,4′-methylenebis(phenyl isocyanate) and toluene diisocyanate; and
(iv) a copolymer derived from the co-condensation of 1H,3H-Benzo[1,2-c:4,5-c′] difuran-1,3,5,7-tetrone with 5,5′-carbonylbis[1,3-isobenzofurandione], 1,3-diisocyanato-2-methylbenzene and 2,4-diisocyanato-1-methylbenzene.

39. A process according to any one of claims 1 to 37 wherein the selectively permeable membrane is formed from or comprises a material selected from a ceramic material suitable for constructing microporous membranes including silicon carbide, silicon oxide, zirconium oxide, titanium oxide, and zeolites.

40. A process according to any one of the preceding claims wherein the selectively permeable membrane is a composite membrane.

41. A process according to any one of the preceding claims wherein the membrane is non-porous and is formed from or comprises a material selected from modified polysiloxane based elastomers including polydimethylsiloxane (PDMS) based elastomers, ethylene-propylene diene (EPDM) based elastomers, polynorbornene based elastomers, polyoctenamer based elastomers, polyurethane based elastomers, butadiene and nitrile butadiene rubber based elastomers, natural rubber, butyl rubber based elastomers, polychloroprene (Neoprene) based elastomers, epichlorohydrin elastomers, polyacrylate elastomers, polyethylene, polypropylene, polytetrafluoroethylene (PTFE), polyvinylidene difluoride (PVDF) based elastomers, and mixtures thereof.

42. A process according to any one of the preceding claims wherein the membrane comprises a reinforcing material selected from an external mesh and support.

43. A process according to any one of the preceding claims wherein the membrane is a composite membrane comprising a porous support and at least one non-porous layer.

44. A process according to claim 43 where the porous support is formed from or comprises a material selected from polymeric material suitable for fabricating microfiltration, ultrafiltration, nanofiltration or reverse osmosis membranes, including polyethylene, polypropylene, polytetrafluoroethylene (PTFE), polyvinylidene difluoride (PVDF), polyethersulfone, polyacrylonitrile, polyamide, polyimide, cellulose acetate, and mixtures thereof.

45. A process according to any one of the preceding claims wherein the process is performed in a continuous manner.

46. A process according to any one of claims 1 to 44 wherein the process is performed in a discontinuous manner.

47. A process according to any of the preceding claims wherein the membrane is pretreated by soaking in a constituent of the composition prior to being used for PTA separation.

48. A process according to any of claims 5 to 47 wherein the ratio of PTA to at least one PTC reactant on a molar percentage basis at the start of step (a) is in the range 0.1-200 mol %.

49. A process according to any of the preceding claims wherein a transition metal is present as a co-catalyst which is retained by the selectively permeable membrane.

50. A process according to any of the preceding claims wherein the process is performed above or below ambient temperature during step (ii).

51. A process as substantially hereinbefore described with reference to any one of the Examples.
